(19) United States
(12) Patent Application Publication
(10) Pub. No.: US 2007/0040456 A1
(43) Pub. Date: Feb. 22, 2007

(54) Linear compressor, particularly refrigerant compressor

(75) Inventors: Poul Erik Hansen, Sydals (DK); Klaus Reinwand, Harrislee (DE); Kaja Lenz, Soenderborg (DK); Frank Holm Iversen, Padborg (DK)

Correspondence Address: MCCORMICK, PAULDING & HUBER LLP, CITY PLACE II, 185 ASYLUM STREET, HARTFORD, CT, 06103, US

(73) Assignee: Danfoss Compressors GmbH, Flensburg (DE)

(21) Appl. No.: 11/501,275

(22) Filed: Aug. 9, 2006

(30) Foreign Application Priority Data
Aug. 17, 2005 (DE) 10 2005 038 781.0

(51) Int. Cl. H02K 41/00

(52) U.S. Cl. 310/14; 417/417; 310/12

(57) ABSTRACT

The invention concerns a linear compressor (1), particularly a refrigerant compressor, with a linear motor (4), which comprises an outer stator (18), an inner stator (20) and an armature (22) located in a gap (21) between outer stator (18) and inner stator (20), and a compression unit (3), which has a cylinder (8) and a piston (16) reciprocating in the cylinder (8) and being connected to the armature (22). It is endeavoured to simplify the design of the compressor. For this purpose, the inner stator (20) and the outer stator (18) are held and positioned in relation to each other at both axial ends by means of motor covers (29).

### CROSS-REFERENCE TO RELATED APPLICATIONS

Applicant hereby claims foreign priority benefits under U.S.C. § 119 from German Patent Application No. 10 2005 038 781.0 filed on Aug. 17, 2005, the contents of which are incorporated by reference herein. This Application relates to German Patent Applications No. 10 2005 038 783.7 (Attorney Docket No. 6495-0168); No. 10 2005 038 784.5 (Attorney Docket No. 6495-0169); No. 10 2005 038 785.3 (Attorney Docket No. 6495-0170); No. 10 2005 038 780.2 (Attorney Docket No. 6495-0173), filed on the same date herewith.

### FIELD OF THE INVENTION

The invention concerns a linear compressor, particularly a refrigerant compressor, with a linear motor, which comprises an outer stator, an inner stator and an armature located in a gap between outer stator and inner stator, and a compression unit, which has a cylinder and a piston reciprocating in the cylinder and being connected to the armature.

### BACKGROUND OF THE INVENTION

Such linear compressors are, for example, known from U.S. Pat. No. 6,793,470 B2 and US 2004/0047751 A1. The outer stator and the inner stator are connected to each other via a relatively massive frame on an end of the stator.

Such a design gives a relatively large weight, but does not in all cases provide satisfactory operating results, as in this way it is difficult to make the gap between inner stator and outer stator, in which the armature moves, with the desired accuracy.

### BRIEF SUMMARY OF THE INVENTION

The invention is based on the task of simplifying the design of the compressor.

With a linear compressor as mentioned in the introduction, this task is solved in that the inner stator and the outer stator are held and positioned in relation to each other at both axial ends by means of motor covers.

This gives a unique and safe orientation of the individual parts of the stator relative to each other. The connection between the motor covers and the stator parts can be relatively weak, as no risk exists here that the stator elements will tilt in relation to the motor covers. The motor covers fix the stator parts in the desired orientation in relation to each other from both axial ends.

Preferably, both motor covers are identically formed. This simplifies storing and mounting. Further, it is favourable, when the linear motor is at least approximately symmetrical, as this has a favourable influence on the magnetic forces and permits the movements of the armature in relation to the stator in both movement directions to be of similar nature.

Preferably, the motor covers are made as stamped and cold-forges metal sheet parts. This reduces the manufacturing costs. At the same time, this makes it possible to manufacture the parts with sufficient tolerance.

Preferably, a first motor cover forms a basis for the cylinder. Thus, the first motor cover not only fixes the stator parts in relation to each other, it also aligns the cylinder to the motor. This makes it possible in a simple manner to hold the cylinder centrically to the motor. Frictional losses are reduced.

It is preferred that the first motor cover is connected to the cylinder by means of an intermediary piece, which forms, at least section-wise, a hollow cylinder, into which the cylinder is inserted. This embodiment gives advantages during mounting. It is endeavoured to make the dead volume, that is, the volume of a compression chamber, which is bordered by the piston and the cylinder, when the piston is in its upper dead point, as small as possible. This can now be done in a simple manner in that during mounting the piston is moved to its upper dead point and the cylinder is then displaced in the intermediary piece in relation to the piston, until the desired minimal dead volume has been reached. In this position the cylinder can then be connected to the intermediary piece, for example by welding, soldering or gluing.

Preferably, the intermediary piece surrounds a section of the first motor cover with reduced cross section and bears axially on the first motor cover. This is a simple way of positioning the cylinder relative to the motor via the intermediary piece. The motor cover is positioned on the stator. The intermediary piece is positioned radially and axially on the motor cover. As mentioned above, the cylinder can be displaced relative to the motor in the movement direction of the piston. In the radial direction, the cylinder is sufficiently fixed by the intermediary piece.

Preferably, a second motor cover carries a resonance spring arrangement. It is favourable, when the linear motor is connected to a resonance spring arrangement, whose resonance frequency is adapted to the operation frequency of the linear motor. In this case, the linear compressor can be operated with a smaller energy consumption. The resonance spring arrangement can now be fixed on the second motor cover in a simple manner, to obtain a radial and axial allocation of the resonance spring arrangement to the linear motor.

In an advantageous embodiment, it is ensured that the inner stator has several inner stator segments arranged to form a cylindrical surface, each inner stator segment having on each end radially inwards a circular recess, which engages a circular projection of the motor cover. In this case, the inner stator segments are made as curved elements. According to their number, they cover in the circumferential direction nearly one third or nearly one fourth of the circumference of a cylinder. By means of the projection of the motor cover and the corresponding recess on the radial inside, the inner stator segments are now positioned in relation to each other in the radial direction.

It is preferred that the bottom of the recess of each inner stator segment bears on the end of the projection. Thus, the inner stator segments are also positioned in relation to each other in the axial direction with a high accuracy. The end of the projection and the bottom of the recess can be manufactured with corresponding accuracy, so that the axial positioning is ensured.

Preferably, the radial outside of the end of each inner stator segment has a recess, which engages a flap bent out from a front wall of the motor cover. Thus, the inner stator segments are supported from the radial outside and from the radial inside. They are fixed in such a manner that not even larger magnetical forces can press them out of their position.

Preferably, for each inner stator segment, at least one radial support projects from the projection, the support being located laterally next to the inner stator segment. Thus, the inner stator segments are fixed also in the circumferential direction in a simple manner.

In a preferred embodiment, it is ensured that the outer stator has several outer stator segments, which rest on the inside of the motor cover and are located in the circumferential direction between two front wall sections bent out from the motor cover. On their outer circumference, the outer stator segments can form some kind of polygon. In the radial direction, their ends extend beyond an opening, which is formed by two front wall sections bent out from the motor cover. These two front wall sections then hold the outer stator segments in the circumferential direction.

It is preferred that the motor cover comprises an outer projection, which annularly surrounds the outer stator segments axially on a predetermined length. This outer projection fixes the outer stator segments on the radial outside.

It is also advantageous, when the outer projection engages in a circular recess, which is formed on the end of the outer stator segments. Thus, the outer diameter of the cover does not have to be larger than that of the outer stator.

Advantageously, the radial inside of each outer stator segment bears on an inner projection bent out from the motor cover. This inner projection then secures the outer stator segment against a movement radially inwards. All fixing elements mentioned until now, which fix the outer stator segments radially outwards or inwards or in the circumferential direction, can be manufactured in a punching and bending process. Thus, the motor cover requires no further elements. The manufacturing of such a motor cover can take place in only a few work steps, which can to a great extent be automated.

Preferably, the motor covers are clamped together by means of screw bolts. This gives a sufficiently fixed connection for holding the stator together with the required forces.

It is also advantageous, when the piston is connected to the armature and/or to the resonance spring arrangement via a piston rod, which is guided through the motor cover in a touch-free manner.

### BRIEF DESCRIPTION OF THE DRAWINGS

In the following, the invention is described on the basis of a preferred embodiment in connection with the drawings, showing:

FIG. 1 is a schematic longitudinal section through a linear compressor;

FIG. 2 is an enlarged view of the stator of the linear compressor in a longitudinal section;

FIG. 3 is a perspective view of a motor cover; and

FIG. 4 is a top view of the motor cover.

### DETAILED DESCRIPTION OF THE INVENTION

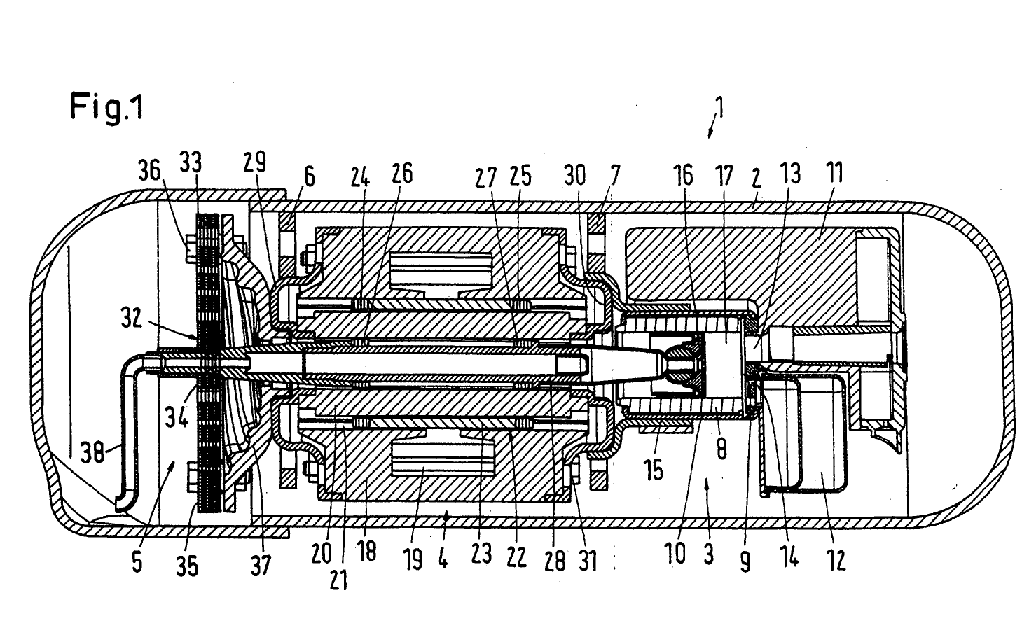

FIG. 1 shows a linear compressor 1, which is located in a hermetically closed case 2.

The linear compressor 1 has a compression section 3, a drive section 4 and a resonance spring arrangement 5. The unit formed by the compression section 3, the drive section 4 and the resonance spring arrangement 5 is suspended in the case 2 by means of two plane annular springs 6, 7, each being formed as a spiral with one winding. The annular springs 6, 7 are fixed on the drive section 4.

The compression section 3 has a cylinder 8, whose one end is covered by a cylinder head 9. Cylinder 8 and cylinder head 9 are joined in a case 10 in a cartridge-like manner. A suction muffler 11 and a pressure muffler 12 are fixed on the cylinder head 9. The suction muffler 11 is connected to a suction opening 13 and the pressure muffler 12 is connected to a pressure opening 14 in the cylinder head.

The case 10 is inserted in an intermediary ring 15, which is connected to the drive section 4. During mounting, the case 10 and thus the cylinder 8 can be displaced within certain limits in the axial direction of the cylinder in relation to the intermediary ring 15. When, as described below in detail, a predetermined position of the cylinder in relation to the drive section 4 has been reached, the case 10 is fixed in the intermediary ring 15, for example by welding, soldering or gluing.

In the cylinder 8 is located a piston 16, which borders a compression chamber 17 together with the cylinder 8 and the cylinder head 9. Before the cylinder with the case 10 is fixed in the intermediary piece 15, the piston 16 is moved to its upper dead point (in FIG. 1: right), and the cylinder 8 with the case 10 is displaced, until the compression chamber 17 has reached its smallest permissible extension.

The drive section 4 has a linear motor. The linear motor has an outer stator 18 with a recess 19 for a winding, not shown in detail, and an inner stator 20. Between the outer stator 18 and the inner stator 20 is an annular gap 21, in which an armature 22 is movable. The armature carries permanent magnets 23, which are connected to each other by means of two outer rings 24, 25. The outer rings 24, 25 can, for example, be made of a plastics material. The outer rings 24, 25 are connected to inner rings 26, 27 via arms (not shown in detail), which are guided through slots in the inner stator 20.

The inner rings 26, 27 are connected with a piston rod 28, which again is connected to the piston 16.

The outer stator 18 and the inner stator 20 are connected to each other via motor covers 29, 30, which are fastened against each other by means of screw bolts 31. The screw bolts extend in parallel to the movement direction of the piston rod 28.

The stators 18, 20 can also be connected to each other by riveting or welding the motor covers 29, 30 to the outer stator 18.

The intermediary ring 15 is connected to the cylinder-side motor cover 30, for example by soldering, gluing or welding.

The resonance spring arrangement 5, which is located at an end of the drive section 4, which lies opposite the compression section 3, has a spring pack 32 of several plate springs 33. The spring pack 32 is connected in a central area 34 to the piston rod 28. An outer section 35 of the spring pack 32 is connected via bolts 36 to a stop housing 37, which forms a stop for the spring pack 32.

At the end projecting from the spring pack 32, the piston rod 28 is connected to an oil pump arrangement 38, which immerses in an oil sump, not shown in detail, which forms in the bottom part of the case 2.

When the winding located in the recess 19 is energised, the armature 22 moves in one direction and takes along the piston rod 28 in this direction. If the direction of the current is reversed, the armature 22 with the piston rod 28 moves in the opposite direction, thus also moving the piston 16 in the opposite direction. This periodically increases and reduces the volume of the compression chamber 17. The resonance spring arrangement 5 is adapted to the frequency of the current, so that the movable part of the linear compressor 1, which is formed by the armature 22, the piston rod 28, the piston 16, the oil pump arrangement 38 and the moving part of the resonance spring arrangement 5 oscillates in resonance.

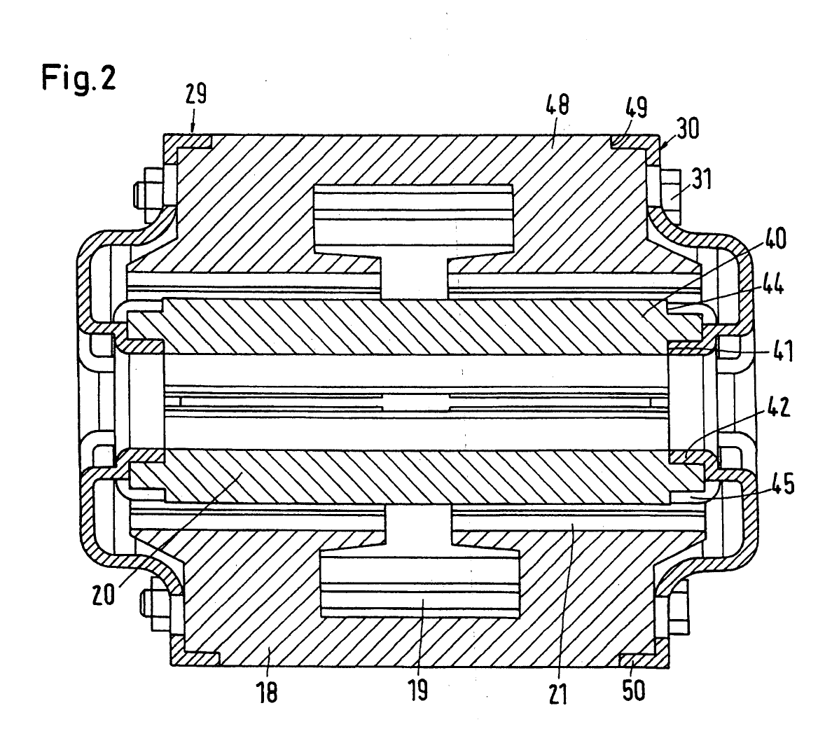

FIG. 2 shows an enlarged view of the stator of the drive section 4. Same elements have the same reference numbers as in FIG. 1.

As both motor covers 29, 30 are made to be identical, the following explanation concerns the motor cover 30. However, the same applies for motor cover 29.

Both motor covers 29, 30 are made as punched and cold-forged sheet metal parts. This means that they can be made in a cost effective manner and in few automatic work steps.

The inner stator 20 comprises several, in the present case three, inner stator segments 40, of which one is drawn with dotted lines in FIG. 4.

The end of each inner stator segment 40 has a recess 41 on its radial inside, which engages a circular projection 42 that surrounds an opening 43, through which the piston rod 28 is guided in a touch-free manner. This is possible, as, outside the drive section 4, the piston rod is fixed in the compression section 3 and in the resonance spring arrangement 5.

The inner stator segment 40 now bears on the end of the projection 42 with the bottom of the recess 41. Thus, the inner stator segment 40 is fixed in relation to the motor cover 30 in the axial direction and radially inwards. The end of the projection 42 can be made with sufficient accuracy.

On the radial outside of the inner stator segment 40 is also provided a circumferential recess 44, in which a flap 45 engages, which is bent out from the motor cover 30. The bending out causes a punched opening 46, which is, however, uncritical, as it lies in the area of the annular gap 21.

By means of the flaps 45, each inner stator segment 40 is fixed radially outwards, the flaps 45 engaging the inner stator segments 40 in the area of their corners.

A fixing of the inner stator segment 40 in the circumferential direction is caused by a radially extending support 47, which is located laterally next to the inner stator segment 40.

When the two motor covers 29, 30 are axially fixed on each other by means of the screw bolts 31, the inner stator segments 40 cannot move in the axial direction, as here they are held by the ends of the motor covers 29, 30. A deflection towards the radial inside is prevented by the projection 42. A deflection towards the radial outside is prevented by pairs of flaps 45 engaging the lateral areas of the inner stator segments 40. A deflection in the circumferential direction is prevented by the supports 47.

In a similar manner, the outer stator 18 has several, in the present embodiment six, outer stator segments 48, which are also supported on the motor covers 29, 30.

As can be seen from FIG. 2, the outer stator segments 48 have a circular recess 49 on their radial outside, in which recess an outer projection 50 of the motor cover 30 engages. The outer projection 50 secures the outer stator segments 48 radially outwards. In the axial direction, the outer stator segments 48 are held by the end of the motor cover 30.

In the circumferential direction, the outer stator segments 48 are held by front wall sections 51 bent out from the motor cover 30. Also these front wall sections 51 are punched and then bent out. This gives an opening 52, which is, however, uncritical for the positioning of the outer stator segments 48, as they only cover a share of the end face of the outer stator segments 48.

Radially inwards, the outer stator segments 48 are secured by inner projections 53, of which one is shown in FIG. 4. Of course, such an inner projection 53 is available for each outer stator segment 48.

In many cases, however, such inner projections are not at all required, as the outer stator segments 48 meet radially inside. When they are kept together in the circumferential direction by the motor cover 30, a deflection radially inwards by the individual outer stator segments 48 is practically not possible. However, the inner projections 53 can be used as safety.

In such an embodiment, slots having the width of the supports 47 remain between the individual inner stator segments 40. These slots can be used to guide the arms, which connect the rings 24, 25 to the inner rings 26, 27.

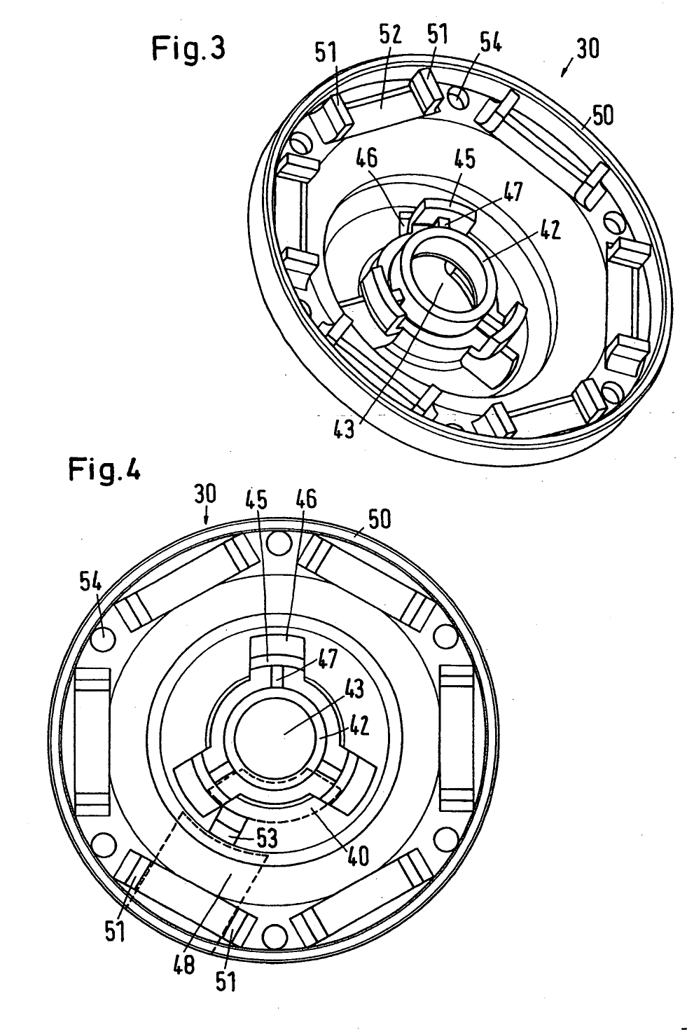

In the FIGS. 3 and 4 openings 54 can be seen, through which the screw bolts 31 are guided to fix the motor covers 29, 30 to each other. Also these openings can be made during punching of the motor covers 29, 30.

While the present invention has been illustrated and described with respect to a particular embodiment thereof, it should be appreciated by those of ordinary skill in the art that various modifications to this invention may be made without departing from the spirit and scope of the present invention.

What is claimed is:

1. A linear compressor, particularly a refrigerant compressor, with a linear motor, which comprises an outer stator, an inner stator and an armature located in a gap between outer stator and inner stator, and a compression unit, which has a cylinder and a piston reciprocating in the cylinder and being connected to the armature, wherein the inner stator and the outer stator are held and positioned in relation to each other at both axial ends by means of motor covers.

2. The linear compressor according to claim 1, wherein both motor covers are identically formed.

3. The linear compressor according to claim 1, wherein the motor covers are made as stamped and cold-forged metal sheet parts.

4. The linear compressor according to claim 1, wherein the first motor cover forms a basis for the cylinder.

5. The linear compressor according to claim 4, wherein the first motor cover is connected to the cylinder by means of an intermediary piece, which forms, at least section-wise, a hollow cylinder, into which the cylinder is inserted.

6. The linear compressor according to claim 5, wherein the intermediary piece surrounds a section of the first motor cover with reduced cross section and bears axially on the first motor cover.

7. The linear compressor according to one of the claim 1, wherein a second motor cover carries a resonance spring arrangement.

8. The linear compressor according to claim 1, wherein the inner stator has several inner stator segments arranged to form a cylindrical surface, each inner stator segment having on each end radially inwards a circular recess, which engages a circular projection of the motor cover.

9. The linear compressor according to claim 8, wherein the bottom of the recess of each inner stator segment bears on the end of the projection.

10. The linear compressor according to claim 8, wherein the radial outside of the end of each inner stator segment has a recess, which engages a flap bent out from a front wall of the motor cover.

11. The linear compressor according to claim 8, wherein for each inner stator segment, at least one radial support projects from the projection, the support being located laterally next to the inner stator segment.

12. The linear compressor according to one of the claim 1, wherein the outer stator has several outer stator segments, which rest on the inside of the motor cover and are located in the circumferential direction between two front wall sections bent out from the motor cover.

13. The linear compressor according to claim 12, wherein the motor cover comprises an outer projection, which annularly surrounds the outer stator segments axially on a predetermined length.

14. The linear compressor according to claim 13, wherein the outer projection engages in a circular recess, which is formed on the end of the outer stator segments.

15. The linear compressor according to claim 13, wherein the radial inside of each outer stator segment bears on an inner projection bent out from the motor cover.

16. The linear compressor according to one of the claim 1, wherein the motor covers are clamped together by means of screw bolts.

17. The linear compressor according to claim 1, wherein the piston is connected to the armature and/or to the resonance spring arrangement via a piston rod, which is guided through the motor cover in a touch-free manner.
